(19) United States
(12) Patent Application Publication
(10) Pub. No.: US 2019/0112846 A1
(43) Pub. Date: Apr. 18, 2019

(54) HANDLE FOR A VEHICLE DOOR

(71) Applicant: U-SHIN Deutschland Zugangssysteme GmbH, Erdweg (DE)

(72) Inventors: Anthony LAVAL, ERDWEG (DE); Régis GRENOUILLAT, ERDWEG (DE); Andreas JURACHEK, ERDWEG (DE); Anton LINDER, ERDWEG (DE)

(73) Assignee: U-SHIN Deutschland Zugangssysteme GmbH, ERDWEG (DE)

(21) Appl. No.: 16/214,441

(22) Filed: Dec. 10, 2018

Related U.S. Application Data
(63) Continuation of application No. PCT/EP2017/063848, filed on Jun. 7, 2017.

(30) Foreign Application Priority Data
Jun. 8, 2016 (EP) 16173447.0

(51) Int. Cl. E05B 85/10

(52) U.S. Cl. CPC E05B 85/107; E05Y 2900/531; E05B 85/103

(57) ABSTRACT

A handle for a vehicle door includes a grip member configured to cooperate with a latch mechanism to unlatch the door. The grip member includes a gripping part and is movable between a flushing position in which the gripping part extends flush to an external panel of the door, an active position in which the gripping part projects with respect to the external panel and becomes graspable, and an opening position in which the grip member cooperates with the latch mechanism to activate the latch mechanism and to unlatch the door. The handle further includes a driving mechanism moving in rotation according to a driving rotation axis and configured to drive an actuator lever cooperating with the grip member, and a motor cooperating with the driving mechanism for moving said driving mechanism according to the driving rotation axis.

### CROSS-REFERENCE TO RELATED APPLICATIONS

This application is a continuation of International Application No. PCT/EP2017/063848, filed on Jun. 7, 2017, which claims priority to and the benefit of EP 16173447.0 filed on Jun. 8, 2016. The disclosures of the above applications are incorporated herein by reference.

### FIELD

The present disclosure relates to a handle for a vehicle door for an automotive vehicle capable of moving the vehicle door, as well as an automotive vehicle comprising such a handle.

### BACKGROUND

The statements in this section merely provide background information related to the present disclosure and may not constitute prior art.

It is known that flush handles comprising a grip member may be configured to cooperate with a latch mechanism to unlatch a door, and the grip member comprises a gripping part configured to be gripped by a user's hand. The grip member is movable between a flushing position in which the gripping part extends flush to an external panel of the door, an active position in which the gripping part projects with respect to the external panel and becomes graspable, and an opening position in which the grip member cooperates with the latch mechanism to activate the latch mechanism and to unlatch the door.

Known flush handles also comprise a driving mechanism moving in rotation according to an actuator rotation axis and intended to drive an actuator lever cooperating with the grip member for driving the grip member between the flushing position and the active position, and a motor cooperating with the driving mechanism for moving said driving mechanism according to the driving rotation axis: such a handle is known in particular from FR2889553.

The current flush handles do not allow a good control of the flushing position.

Indeed, it is difficult to keep constant the time for passing from one flushing position to another with constant power supply voltage under any environmental conditions and between all vehicle doors. All these doors may have their own tolerances and the mechanical properties of one single component of the handle depend on the temperature range. For example, there is higher friction between moving parts at low temperature, lower friction at high temperature, and amendment of performance characteristics of the motor in terms of torque or rotation speed or change of power supply voltage from the control unit controlling the electrical parts of the handle due to battery wear.

This may lead to a non simultaneous opening and closing of all handles and to the change of said opening and closing time over the vehicle life time. This non regularity accounts for the global non quality impression of the whole vehicle.

### SUMMARY

According to an aspect, the present disclosure includes a handle for a vehicle door, comprising:

a grip member configured to cooperate with a latch mechanism to unlatch the door, wherein the grip member comprises a gripping part, the grip member being movable between a flushing position in which the gripping part extends flush to an external panel of the door, an active position in which the gripping part projects with respect to the external panel and becomes graspable, and an opening position in which the grip member cooperates with the latch mechanism to activate the latch mechanism and to unlatch the door;

a driving mechanism moving in rotation according to a driving rotation axis and configured to drive an actuator lever cooperating with the grip member for driving the grip member between the flushing position and the active position;

a motor cooperating with the driving mechanism for moving said driving mechanism according to the driving rotation axis, said motor is configured to be connected to a control unit;

wherein said handle further includes a position determining assembly for determining the rotation position of the driving mechanism while said driving mechanism is rotating, said position determining assembly configured to be connected to the control unit which adapts the rotation speed of the motor according to the rotation position of the driving mechanism; and

wherein said handle is characterized in that the position determining assembly comprises a magnet rotated by the driving mechanism according to a magnet rotation axis and a Hall effect position sensor.

Using the Hall effect position determining assembly, it is possible to determine the angular position of the driving mechanism and then the position of the actuator lever and to give the information to the unit control of the handle. The unit control is then able to determine the intermediate position of the handle at any time during the opening or closing movement. This information enables a detection of any unexpected position and an appropriate reaction in eventually stopping the power supply of the actuator lever. Moreover, this information about position and speed of the handle enables a better control the opening or closing to achieve a smooth and simultaneous movement of all vehicle handles.

According to various forms which can be considered alone or in combination:

the position determining assembly is connected directly to the driving mechanism;

the magnet comprises one or several blades to enable said magnet to closely follow the rotation of the driving mechanism;

the magnet is rotated by a sensor gear wheel rotated by the driving mechanism;

the sensor gear wheel cooperates with one or an assembly of driving wheels following the rotation of the driving mechanism;

the Hall effect position sensor is placed on a printed circuit board disposed in a plane sensibly parallel to the plan in which the magnet is placed, said printed circuit board is connected to the control unit;

the driving mechanism and the actuator lever is power supplied by the unit control;

the output shaft of the motor has a motor rotation axis sensibly perpendicular to the driving rotation axis and the lever rotation axis;

the driving rotation axis is sensibly perpendicular to the lever rotation axis and to the output shaft of the motor;

the magnet rotation axis is sensibly parallel to the driving rotation axis;

the actuator lever is driven in rotation or in translation by the driving mechanism;

the driving mechanism comprises at least one brake system for adapting the speed of the actuator lever; and/or

the driving mechanism comprises a clutch system in order to enable the grip member to move from the opening position to the flush position.

Another aspect of the present disclosure relates to an automotive vehicle comprising a door and a handle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an interior of a handle according to one form of the present disclosure;

FIG. 2 is a schematic 3D perspective view of the handle in FIG. 1 including the motor, the driving mechanism, the actuator lever and the position determining assembly;

FIG. 3 is a schematic side view of the form of FIG. 2;

FIG. 4 is a schematic bottom view of the form of FIG. 2;

FIG. 5 is a schematic view of a part of the handle of a variant of the handle in FIG. 1 including the motor, the driving mechanism, the actuator lever and the position determining assembly;

FIG. 6 is a partial perspective view of the form of FIG. 2;

FIG. 7 is a partial perspective view of the form of FIG. 2;

FIG. 8 is a side view of the form of FIG. 5;

FIG. 9 is a view corresponding of the detail view IX of FIG. 8;

FIG. 10 is a partial perspective view of the detail view X of FIG. 8;

FIG. 11 is a top view of the gear of the form of FIG. 5; and

FIG. 12 is a partial exploded perspective view of the gear of the form of FIG. 11.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As shown in FIG. 1, the handle 1 of the present disclosure is a motorized handle which enables the closing and opening of a vehicle door (not shown). The handle comprises a grip member 3 configured to cooperate with a latch mechanism (not shown) so as to unlatch the door. The grip member 3 comprises a gripping part 5 which is configured to be gripped by the user hand.

The grip member 3 is movable between:

a flushing position in which the gripping part 5 extends flush to an external panel (not shown) of the door, in other words the external side of the gripping part 5 is in continuity with the external side of the external panel,

an active position in which the gripping part 5 projects with respect to the external panel and becomes graspable, and

an opening position in which the grip member 3 cooperates with the latch mechanism to activate the latch mechanism and to unlatch the door.

The handle 1 of the present disclosure also comprises a driving mechanism 11 moving in rotation according to a driving rotation axis 13 and configured to drive an actuator lever 15 cooperating with the grip member 3 for driving the grip member 3 between the flushing position and the active position. The actuator lever 15 may be driven in rotation or in translation by the driving mechanism 11.

The driving mechanism 11 may be a part of the actuator lever 15 forming an element or may be distinct of the actuator lever 15, as shown in the figures.

The actuator lever 15 may be movable in translation or in rotation as shown in alternative forms of the figures. In case the actuator lever is movable in rotation, the latter comprises a lever rotation axis 14. According to one form, the movement of the handle 1 of the present disclosure for the opening or the closing may be achieved by a direct contact with a rotational moving part of the actuator lever 15, as shown in the figures.

According to one form, the movement of the handle 1 of the present disclosure for the opening or closing may be achieved by a direct contact with a translational moving part of an actuator lever.

According to another form, the movement of the handle 1 of the present disclosure for the opening or closing may be achieved by a direct contact with rotational moving part acting like a lever which could be driven by a translational actuator lever.

The driving mechanism 11 may also comprise at least one brake system (not shown) for adapting the speed of the actuator lever 15. Such brake system may be a mechanical friction based brake, a magnetically brake without power supply or an electro-magnetically brake with external power supply.

The handle 1 of the present disclosure further comprises a motor 21 cooperating with the driving mechanism 11 for moving said driving mechanism 11 according to the driving rotation axis 13. The output shaft 22 of the motor 21 may have a motor rotation axis 23 sensibly perpendicular to the driving rotation axis 13 which enables to reduce space.

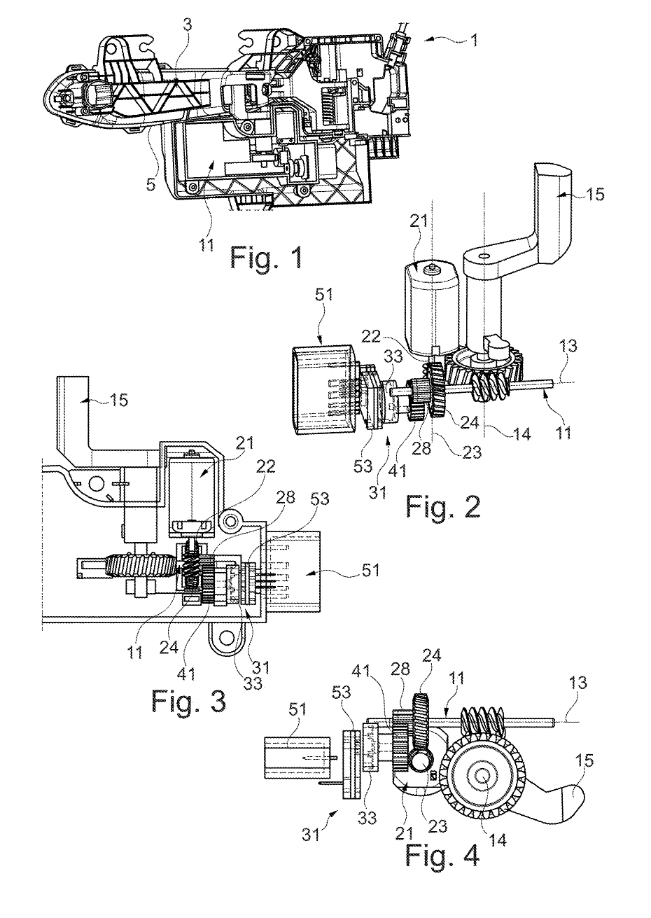

As shown in FIGS. 2 to 4, the driving rotation axis 13 is sensibly perpendicular to the lever rotation axis. In this form, the driving rotation axis 13 is also sensibly perpendicular to output shaft 22 of the motor 21. Such configuration enables to reduce the space of the handle of the present disclosure.

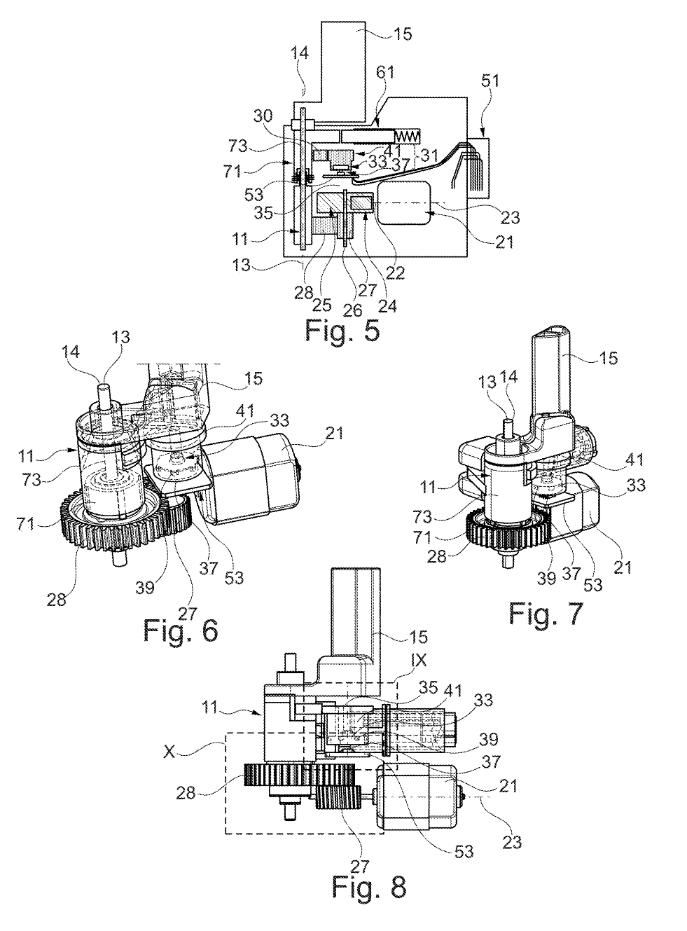

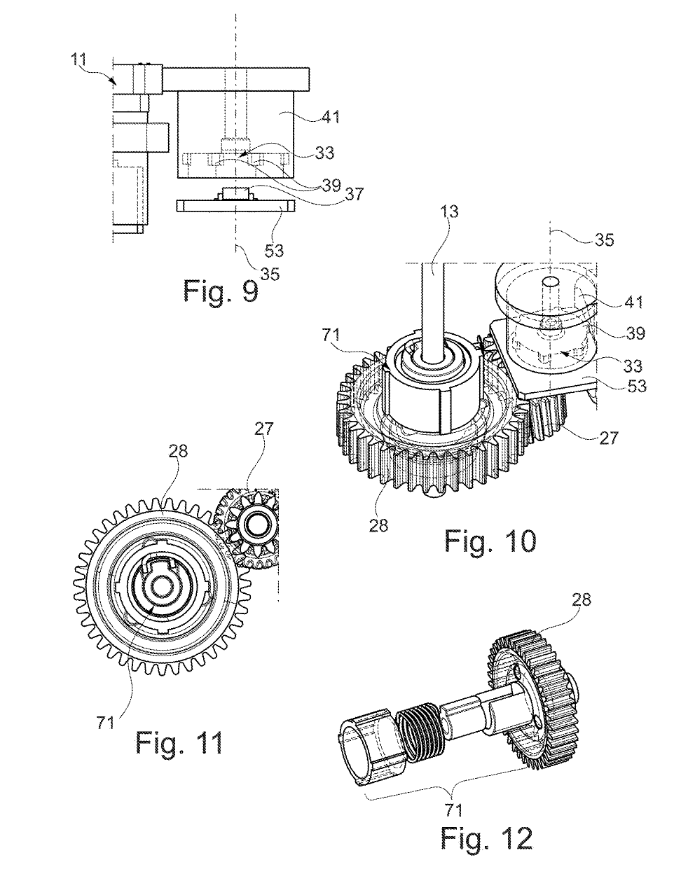

As shown in FIGS. 5 to 12, the driving rotation axis 13 is sensibly parallel and apart from the lever rotation axis and the driving rotation axis 13 is also sensibly perpendicular to output shaft 22 of the motor 21 which is then perpendicular to the lever rotation axis 14.

The output shaft 22 of the motor may be connected to a worm 24, such as a worm wheel, which rotates a first intermediate gear 25 with a bigger diameter. Such gear 25 may rotate a wheel shaft 26 which rotate a second intermediate gear 27 with a smaller diameter which rotates the driving mechanism 11, via for example a first end driving gear 28.

The gear assembly comprising all the gears 24, 25, 27 and 28 involved in the connection between the motor movement and the driving mechanism movement may be reversible or not. The reversibility is possible via an appropriate friction between all the gears 24, 25, 27 and 28.

In a first alternative, the gear assembly may be designed as to be non reversible, for example with a proper choice of the helix angle of the worm 24 and the first intermediate gear 25. As illustrated in FIGS. 10 to 12, the driving mechanism 11 comprises a clutch system 71 because the cinematic of the gears is not reversible. For authorizing the movement of the handle by the user, said clutch 71 is needed in a functional point of view. The clutch system 71 may be a mechanical clutch, such as a wrap-spring based concept, or an electro-magnetically clutch.

The second end driving gear of the gear assembly opposite to the first end driving gear may be connected to said clutch system 71.

The driving mechanism 11 may then comprise a driving output lever 73 with a specific shape like a cam profile on one end, in order to directly or indirectly drive the gripping part 5 during the opening or closing movement of the handle 1 of the present disclosure.

The driving output lever 73 is then rotated in one direction for the opening of the handle 1 of the present disclosure and in the reverse direction for the closing of the handle 1 of the present disclosure. The change in the direction of rotation of the driving output lever 73 is achieved in changing the rotation direction of the motor 21. By way of example, the change of rotation of the motor 21 may be done by reversing the power supply.

The clutch system 71 may be designed in order to engage the connection between the gear assembly and the driving output lever 73 when the torque is coming from the motor 21 or the gear assembly stage side whatever the actuation direction is. The clutch system 71 may be disengaged when the torque or force is coming from the output side, for example, from the handle 1 itself or from another mechanical system used for opening or closing in case of loss of battery whatever the direction is. When declutched, the output lever 73 may be freely rotated, for example by the handle 1 of the present disclosure, independently from the gear assembly or the motor 21, which stays in the same position.

In a second alternative shown in the first form in FIGS. 2 to 4, the gear assembly may be designed to be reversible within a defined range of force or torque. No clutch is needed due to the reversibility. The handle may be maneuver by the user directly through the grip member in a reverse way. The second end driving gear may be directly connected to the driving output lever 73. The driving output lever 73 then comprises a specific shape, like a cam profile on its other end, in order to directly or indirectly drive the handle 1 of the present disclosure during the opening or closing movement.

The driving output lever 73 is then rotated in one direction for opening of the handle 1 of the present disclosure and in the reverse direction for the closing of the handle 1 of the present disclosure. The change in the direction of rotation of the driving output lever 73 is achieved in changing the rotation direction of the motor 21, by reversing the power supply for example.

The inner friction inside the gear chain from the driving output lever 73 to the motor 21 is high enough to support the closing force applied by the handle, specifically any main spring insuring a stable position of the handle 1 of the present disclosure. This inner friction may be chosen in order to be low enough to allow manual movement of the handle 1 of the present disclosure by the user directly or through the activation of a mechanical function acting when no energy is powered to the motor 21. The handle 1 of the present disclosure is then designed to respect this given functional friction range over the whole temperature range. This may be done with the proper geometry of the gears 24, 25, 27 and 28 and with the proper material combination including the choice of a lubrication matter.

A supplementary brake may even be used in the kinematic chain in order to add supplementary friction and reach a predetermined target balance between reduced or increased friction values for the function of the reversible handle 1 of the present disclosure.

According to the present disclosure, the handle 1 further comprises a position determining assembly 31, specifically an absolute position determining assembly, for determining the rotation position of the driving mechanism 11 while said driving mechanism 11 is rotating.

Thanks to the present disclosure, the position determining assembly 31 is capable of detecting the angular position of the actuator lever 15 at any time and then the gripping part 5. This is advantageously activated even when the loading torque is coming whether from the motor 21 or the driving mechanism 11 and whatever the rotation direction of the gripping part 5 is.

Another advantage of the position determining assembly 31 is that the flushing position of the handle 1 of the present disclosure may be adjusted during the final assembly of the door sub-components at the automotive vehicle factory, in order to have an accurate flushing position of the handle 1 whatever the tolerances of the door panel and all the other assembled sub-components may be. In that way, each handle 1 of the present disclosure has one specific programmed flushing position.

Furthermore, if the user wants to trigger an action of the handle 1 of the present disclosure, such as an opening or a closing, in slightly pushing or pulling said handle 1, the position determining assembly 31 enables to have access to the change in the position, the direction and/or the speed of the handle 1 of the present disclosure. This information given to the unit control of the handle 1 enables the control of the movement of the actuator lever 15 to perform an action according to the user wish.

The position determining assembly 31 may be advantageously directly connected to the driving mechanism 11 which gives a better time response.

The position determining assembly 31 may detect directly or indirectly a rotational movement or a linear movement of the actuator lever 15 in contact with the gripping part 5.

The position determining assembly 31 may be an incremental sensor system.

The position determining assembly 31 may comprise a magnet 33 rotated by the driving mechanism 11 according to a magnet rotation axis 35 and a Hall effect position sensor 37, specifically an absolute position sensor.

The combination of the magnet 33 and the Hall effect position sensor 37 enables to detect directly the position, the direction and the speed of rotation of the driving mechanism 11. Indeed, each time the magnet 33 rotates, the Hall effect position sensor 37 detects the angular change in the position of the magnet 33 at any time. It is then possible to detect the direction of the rotation and the time of the change which induces the speed of rotation.

The magnet 33 may have a sensibly plane shape, for example a disc type shape, which gives more compactness.

The magnet 33 may comprise one or several blades 39 to enable said magnet 33 to closely follow the rotation of the driving mechanism 11 and then improve the accuracy of the position determining assembly.

The magnet 33 may be advantageously rotated by a sensor gear wheel 41 rotated by the driving mechanism 11. This enables to have a simply and non costly drive means of the magnet 33.

The sensor gear wheel 41 may cooperate with one or an assembly of driving wheels 43 following the rotation of the driving mechanism 11 which enables to have a good movement transmission.

According to a variation not shown, the sensor gear wheel 41 may be a part of the assembly of driving wheels 43. In other words, the sensor gear wheel 41 is implied in the rotation cinematic of the driving mechanism 11.

According to the variation shown in FIGS. 2 to 4, the sensor gear wheel 41 may cooperate with a wheel 28 disposed close to the output shaft 22 of the motor 11 which enables to have a better precision of the angular position of the magnet 33. The sensor gear wheel 41 is then disposed so as to determine directly the rotation of the driving mechanism 11.

According to the variation shown in FIGS. 5 to 12, the sensor gear wheel 41 may cooperate with a wheel 30 disposed close to the lever rotation axis 14.

Typically, the reduction or increase ratio at sensor gear wheel 41 stage may be defined in order to have the best accuracy of the absolute position sensor in adjusting the rotation of the magnet 33 at around 300° for the complete movement. The magnet rotation axis 34 may be sensibly parallel to the driving rotation axis 13. This configuration enables to improve the compactness of the handle 1 of the present disclosure.

The handle 1 of the present disclosure may also comprise a control unit (not shown) for controlling the motor 21 as well the position determining assembly 31. More specifically, the control unit is able to adjust the speed to get the smooth and simultaneous opening/closing of the handle 1 of the present disclosure.

As shown in the figures, the control unit may be connected to the handle 1 of the present disclosure through an external connector 51.

The unit control then acquires directly the data collected by the position determining assembly 31 and then the data relative to the accurate position of the actuator lever 15 and the gripping part 5 at any time, during the opening or closing movement of the handle 1 of the present disclosure or even when the actuator lever 15 is not in operation.

In case of drop in battery voltage or no battery voltage, the position of the handle 1 of the present disclosures available after battery replacement without any calibration cycle to be performed by the unit control. This enables to reduce time and costs.

The Hall effect position sensor 37 may be placed on a printed circuit board 53 disposed in a plane sensibly parallel to the plan in which the magnet 33 is placed, said printed circuit board 53 being connected to the control unit. Such configuration enables to transmit quickly without deficiency the data collected by the sensor 37.

The control unit may advantageously be also connected to the driving mechanism 11 and be able to adapt the position and/or the speed of said driving mechanism 11. Therefore, in a simple way, the movement of the driving mechanism 11 may be adapted depending on the data collected by the sensor 37.

The driving mechanism 11 and the actuator lever 31 may advantageously be power supplied by the unit control instead of conventional constant voltage power supply.

Through the information arising from the position determining assembly 31 during the opening or closing movement, the power supply may therefore be adjusted in a way to compensate the tolerance dispersion of the single parts and tolerances resulting from changing temperature conditions or battery voltage and wear of single components. This adjustment then allows providing a constant opening or closing time between all vehicle doors and over life time of the vehicle. This may be achieved with combination of control loops at the unit control level to reach a pre-defined target position and/or speed profile.

The tolerance range of the timing for opening and closing of the handle 1 of the present disclosure is therefore drastically reduced. This feature allows as well providing a simultaneous movement of all handles of the vehicle, giving a fine quality impression to the user.

This kind of power control enables to keep a low and constant rotation speed of the motor 21, whatever the battery voltage, which will then lead to low noise level and the absence of modulation during operation of the actuator lever 15. These factors account for the noise quality and for the global quality impression of the vehicle.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are configured to be within the scope of the disclosure. Such variations are not to be regarded as a departure from the spirit and scope of the disclosure.

As used herein, the phrase at least one of A, B, and C should be construed to mean a logical (A OR B OR C), using a non-exclusive logical OR, and should not be construed to mean “at least one of A, at least one of B, and at least one of C.

What is claimed is:

1. A handle for a vehicle door, comprising:
a grip member configured to cooperate with a latch mechanism so as to unlatch the vehicle door, wherein the grip member comprises a gripping part, the grip member being movable between a flushing position in which the gripping part extends flush to an external panel of the door, an active position in which the gripping part projects with respect to the external panel and becomes graspable, and an opening position in which the grip member cooperates with the latch mechanism to activate the latch mechanism and to unlatch the door;
a driving mechanism moving in rotation according to a driving rotation axis and configured to drive an actuator lever cooperating with the grip member for driving the grip member between the flushing position and the active position; and
a motor cooperating with the driving mechanism for moving said driving mechanism according to the driving rotation axis, said motor is configured to be connected to a control unit, wherein said handle further comprises a position determining assembly for determining a rotation position of the driving mechanism while said driving mechanism is rotating, said position determining assembly is configured to be connected to the control unit which is able to adapt the rotation speed of the motor according to the rotation position of the driving mechanism.

2. The handle according to claim 1, wherein the position determining assembly is connected directly to the driving mechanism.

3. The handle according to claim 15, wherein the magnet comprises one or several blades to enable said magnet to follow rotation of the driving mechanism.

4. The handle according to claim 15, wherein the magnet is rotated by a sensor gear wheel rotated by the driving mechanism.

5. The handle according to claim 4, wherein the sensor gear wheel cooperates with one or an assembly of driving wheels following rotation of the driving mechanism.

6. The handle according to claim 15, wherein the Hall effect position sensor is placed on a printed circuit board disposed in a plane parallel to a plane in which the magnet is placed, and said printed circuit board is connected to the control unit.

7. The handle according to claim 1, wherein the driving mechanism and the actuator lever are power supplied by the unit control.

8. The handle according to claim 1, wherein an output shaft of the motor has a motor rotation axis perpendicular to the driving rotation axis and a lever rotation axis.

9. The handle according to claim 1, wherein the driving rotation axis is perpendicular to a lever rotation axis and to an output shaft of the motor.

10. The handle according to claim 15, wherein the magnet rotation axis is parallel to the driving rotation axis.

11. The handle according to claim 1, wherein the actuator lever is driven in rotation or in translation by the driving mechanism.

12. The handle according to claim 1, wherein the driving mechanism comprises at least one brake system for adapting a speed of the actuator lever.

13. The handle according to claim 1, wherein driving mechanism comprises a clutch system in order to enable the grip member to move from the opening position to the flush position.

14. An automotive vehicle comprising a door and a handle according to claim 1.

15. The handle according to claim 1, wherein said position determining assembly comprises a magnet rotated by the driving mechanism according to a magnet rotation axis and a Hall effect position sensor.
